(19) United States
(12) Patent Application Publication
(10) Pub. No.: US 2009/0269038 A1
(43) Pub. Date: Oct. 29, 2009

(54) INFORMATION REPRODUCING APPARATUS AND METHOD, AND COMPUTER PROGRAM

(75) Inventors: Nobuyuki Takakuwa, Saitama (JP); Yasuko Fukuda, Saitama (JP); Takeshi Takahashi, Saitama (JP)

Correspondence Address: YOUNG & THOMPSON, 209 Madison Street, Suite 500, ALEXANDRIA, VA, 22314, US

(73) Assignee: PIONEER CORPORATION, TOKYO (JP)

(21) Appl. No.: 12/095,345

(22) PCT Filed: Nov. 27, 2006
(86) PCT No.: PCT/JP2006/323553

§ 371 Date: Jul. 10, 2008

(30) Foreign Application Priority Data
Nov. 30, 2005 (JP) 2005-345331

(51) Int. Cl. H04N 5/91

(52) U.S. Cl. 386/108; 386/E05.003

(57) ABSTRACT

An information reproducing apparatus (200) is provided with: a reproducing device (353) for reproducing normal content data and advance content data whose reproduction is started before launch of an application for controlling reproduction of the normal content data is completed; a first controlling device (354) for controlling the reproducing device to delay the start of the reproduction of the advance content data, for a predetermined period from the start of the launch of the application; a judging device (354) for judging whether or not an instruction related to the reproduction is given in the predetermined period; and a second controlling device (354) for controlling the reproducing device to start the reproduction of the advance content data after the predetermined period has elapsed if it is judged that the instruction is not given

### TECHNICAL FIELD

The present invention relates to an information reproducing apparatus for and method of performing reproduction on an information recording medium, such as an optical disc, and a computer program which makes a computer function as such an information reproducing apparatus.

### BACKGROUND ART

As a next-generation optical disc of a DVD, which is becoming popular, a Blu-ray Disc is under development. In the Blu-ray Disc, a blue laser beam is used to record and reproduce record data, wherein the blue laser beam has a shorter wavelength than that of a red laser beam, which is used to record and reproduce the record data on a DVD. Moreover, by shortening the pitch of tracks formed on a recording surface, the Blu-ray Disc attains a recording capacity of about 23 GB in a signal recording layer (refer to patent documents 1 to 3).

In the Blu-ray Disc, there has been invented a method of reproducing AV contents, such as a movie, in a programmable and highly interactive environment, such as Java (registered trademark). Specifically, there has been invented a method of reproducing the AV contents or the like in various aspects, or in various aspects according to a user's operation, by the operation of an application such as Java. At this time, because it takes a certain degree of time to launch the application such as Java, in order not to lose the user's interest until the launch of the application is completed, it has been also invented to reproduce the AV content or the like, which is reproduced in advance, until the launch of the application is completed. The AV content to be reproduced in advance is specified by e.g. auto play flag. [0004]
Patent document 1: Japanese Patent Application Laid Open NO. 2004-304767
Patent document 2: Japanese Patent Application Laid Open NO. 2004-328450
Patent document 3: Japanese Patent Application Laid Open NO. 2005-269595

### DISCLOSURE OF INVENTION

### Subject to be Solved by the Invention

However, there is such a technical problem that even if the user gives an instruction to reproduce another AV content before the launch of the application is completed, any AV content but the AV content whose reproduction is desired by the user is reproduced because the reproduction of the AV content, which has been already specified by the auto play flag, has been started.

The subject to be solved by the present invention includes the aforementioned problem as an example. It is therefore an object of the present invention to provide an information reproducing apparatus and method, which can reproduce the AV content or the like while appropriately reflecting the user's instruction, and a computer program which makes a computer function as such an information recording apparatus.

### Means for Solving the Subject

The above object of the present invention can be achieved by an information reproducing apparatus provided with: a reproducing device for reproducing at least one of normal content data and advance content data whose reproduction is started before launch of an application for controlling reproduction of the normal content data is completed; a first controlling device for controlling the reproducing device to delay the start of the reproduction of the advance content data, for a predetermined period from the start of the launch of the application; a judging device for judging whether or not an instruction related to the reproduction is given in the predetermined period; and a second controlling device for controlling the reproducing device to start the reproduction of the advance content data after the predetermined period has elapsed if it is judged that the instruction is not given.

The above object of the present invention can be also achieved by an information reproducing method in an information reproducing apparatus provided with: a reproducing device for reproducing at least one of normal content data and advance content data whose reproduction is started before launch of an application for controlling reproduction of the normal content data is completed, the information reproducing method provided with: a first controlling process of controlling the reproducing device to delay the start of the reproduction of the advance content data, for a predetermined period from the start of the launch of the application; a judging process of judging whether or not an instruction related to the reproduction is given in the predetermined period; and a second controlling process of controlling the reproducing device to start the reproduction of the advance content data after the predetermined period has elapsed if it is judged that the instruction is not given.

The above object of the present invention can be also achieved by a computer program for reproduction control and for controlling a computer provided in the information reproducing apparatus of the present invention, the computer program making the computer function as at least one portion of the first controlling device, the judging device, and the second controlling device.

These effects and other advantages of the present invention will become more apparent from the embodiments explained below.

### BRIEF DESCRIPTION OF DRAWINGS

FIG. 1 is a block diagram conceptually showing the basic structure of an information recording/reproducing apparatus in an example.

FIG. 2 is a data structure diagram conceptually showing the logical structure of a title table.

FIG. 3 is a data structure diagram conceptually showing the logical structure of a Java object.

FIG. 4 is a data structure diagram conceptually showing the logical structure of a play list.

FIG. 5 is a cross sectional view showing a new optical disc and a graph showing tracking polarity.

FIG. 6 is a data structure diagram conceptually showing a hierarchical relationship of the data logical structure.

FIG. 7 is a block diagram conceptually showing a logical circuit structure inside a CPU, provided for the information recording/reproducing apparatus, to realize the operation shown in FIG. 6.

### DESCRIPTION OF REFERENCE CODES

10 title table
11 pointer to Java object
12 pointer to play list
20 Java object
21 auto play flag
22 pointer to advance AV content
23 Java application
30 play list
31 play item
100 optical disc
200 information recording/reproducing apparatus
352 optical pickup
353 signal recording/reproducing device
354, 359 CPU

### BEST MODE FOR CARRYING OUT THE INVENTION

Hereinafter the best mode for carrying out the present invention will be explained in embodiments of the information reproducing apparatus and method, and the computer program of the present invention with reference to the drawings.

### Embodiment of Information Reproducing Apparatus

An embodiment of the information reproducing apparatus of the present invention is provided with: a reproducing device for reproducing at least one of normal content data and advance content data whose reproduction is started before launch of an application for controlling reproduction of the normal content data is completed; a first controlling device for controlling the reproducing device to delay the start of the reproduction of the advance content data, for a predetermined period from the start of the launch of the application; a judging device for judging whether or not an instruction related to the reproduction is given in the predetermined period; and a second controlling device for controlling the reproducing device to start the reproduction of the advance content data after the predetermined period has elapsed if it is judged that the instruction is not given.

According to the embodiment of the information reproducing apparatus of the present invention, the normal content data including video data, such as a movie, and audio data, such as music, or the like, is reproduced by the operation of the reproducing device. In the same manner, the reproduction of the advance content data, which is reproduced in advance, is started by the operation of the reproducing device before the launch of the application for controlling the reproduction of the normal content data is completed. The advance content data may include data in the same format as that of the normal content data (e.g. various video data and audio data or the like), or it may include data in a different format from that of the normal content data. Alternatively, the advance content data may be at least one portion of the normal content data. The advance content data is preferably treated separately from the normal content data, by an auto play flag or the like described later.

Moreover, the application is used in reproducing the normal content data in a programmable and relatively highly interactive environment. Therefore, if the normal content data needs to be reproduced in the programmable and relatively high interactive environment, the application is read and starts to be launched. Then, before the application is read and starts to be launched (i.e. before the launch is completed), the reproduction of the advance content data is started. On the other hand, if the normal content data does not have to be reproduced in a programmable and relatively low interactive environment, the normal content data is reproduced.

In particular, in the embodiment, the reproducing device is controlled by the operation of the first controlling device to delay the start of the reproduction of the advance content data for the predetermined period from the start of the launch of the application. That is, the reproduction of the advance content data is not started before the predetermined period has elapsed from the start of the launch of the application.

At this time, it is judged whether or not the instruction related to the reproduction (e.g. a reproduction stop instruction, a fast-forward instruction, a rewind instruction, a chapter selection instruction, an instruction to change a reproduction target, and the like) is given to the information reproducing apparatus by a user or the like, in the predetermined period in which the reproduction of the advance content data is not started.

As a result of the judgment by the judging device, if it is judged that the instruction related to the reproduction is not given by the user or the like in the predetermined period in which the reproduction of the advance content data is not started, the reproducing device is controlled by the operation of the second controlling device to start the reproduction of the advance content data after the predetermined period has elapsed.

As explained above, the reproduction of the advance content data is not started in the predetermined period after the reading and launch of the application are started, and the instruction from the user can be received. Therefore, the reproduction based on the user's instruction can be performed in the predetermined period. In other words, even after the launch of the application is started, it is possible to perform the reproduction based on the user's instruction. Specifically, for example, in the case that the user gives an instruction to start the reproduction of second content data whose reproduction is not controlled by the application after the user gives an instruction to start the reproduction of first content data whose reproduction is controlled by the application, the reproduction of the second content data can be started as long as the instruction to start the reproduction of the second content data is given within the predetermined period from the start of the launch of the application that controls the reproduction of the first content data.

As described above, according to the embodiment of the information reproducing apparatus, it is possible to preferably reproduce the title or the like while appropriately reflecting the user's instruction.

In one aspect of the embodiment of the information reproducing apparatus of the present invention, the application includes a Java application.

According to this aspect, while receiving the aforementioned various benefits, it is possible to reproduce the content data in various aspects specified by the Java application, or in an interactive aspect based on the operation of the Java application.

In another aspect of the embodiment of the information reproducing apparatus of the present invention, the application includes a HTML (Hyper Text Markup Language) application.

According to this aspect, while receiving the aforementioned various benefits, it is possible to reproduce the content data in various aspects specified by the HTML application, or in an interactive aspect based on the operation of the HTML application.

In another aspect of the embodiment of the information reproducing apparatus of the present invention, the application includes an application that operates on a virtual machine which is mounted on the information reproducing apparatus.

According to this aspect, while receiving the aforementioned various benefits, it is possible to reproduce the content data in various aspects specified by the application (e.g. the aforementioned Java application and HTML application or the like) that is executed by the virtual machine which is mounted on the information reproducing apparatus, or in an interactive aspect based on the operation of the application that is executed by the virtual machine which is mounted on the information reproducing apparatus.

In another aspect of the embodiment of the information reproducing apparatus of the present invention, the second controlling device controls the reproducing device to perform the reproduction based on the instruction if it is judged that the instruction is given.

According to this aspect, even after the launch of the application is started, it is possible to perform the reproduction based on the instruction, in the predetermined period from the start of the launch.

In another aspect of the embodiment of the information reproducing apparatus of the present invention, the second controlling device controls the reproducing device to perform the reproduction based on the instruction instead of starting the reproduction of the advance content data.

According to this aspect, even after the launch of the application is started, it is possible to perform the reproduction based on the instruction, in the predetermined period from the start of the launch.

In another aspect of the embodiment of the information reproducing apparatus of the present invention, the predetermined period is less than or equal to a time required from the start of the launch of the application to the completion thereof.

After the launch of the application is completed, the user's instruction is reflected, for example, in the operation of the application, more preferably. Therefore, according to this aspect, even if the launch of the application is not completed, it is possible to perform the reproduction based on the instruction for a while after the launch of the application is started.

Incidentally, the time required for the launch of the application varies depending on the data amount of the application or the like, as occasion demands. Thus, as described later, the predetermined period is preferably set on the basis of the time required for the launch of the application that varies as occasion demands.

In another aspect of the embodiment of the information reproducing apparatus of the present invention, the predetermined period is set on the basis of a time required from the start of the launch of the application to the completion thereof.

According to this aspect, it is possible to set the preferable predetermined period, in accordance with the time required for the launch of the application.

In another aspect of the embodiment of the information reproducing apparatus of the present invention, it is further provided with a setting device for setting the predetermined period on the basis of a time required from the start of the launch of the application to the completion thereof.

According to this aspect, it is possible to set the preferable predetermined period, in accordance with the time required for the launch of the application.

In another aspect of the embodiment of the information reproducing apparatus of the present invention, it is further provided with an inputting device for a user of the information reproducing device to input the instruction to the information reproducing apparatus.

According to this aspect, the user can give the instruction by using the inputting device, such as a remote controller, an operation button, a keyboard, a touch panel and the like.

### Embodiment of Information Reproducing Method

An embodiment of the information reproducing method of the present invention is an information reproducing method in an information reproducing apparatus provided with: a reproducing device for reproducing at least one of normal content data and advance content data whose reproduction is started before launch of an application for controlling reproduction of the normal content data is completed, the information reproducing method provided with: a first controlling process of controlling the reproducing device to delay the start of the reproduction of the advance content data, for a predetermined period from the start of the launch of the application; a judging process of judging whether or not an instruction related to the reproduction is given in the predetermined period; and a second controlling process of controlling the reproducing device to start the reproduction of the advance content data after the predetermined period has elapsed if it is judged that the instruction is not given.

According to the embodiment of the information reproducing method of the present invention, it is possible to receive the same benefits as those of the aforementioned information reproducing apparatus of the present invention.

In response to the various aspects of the aforementioned information reproducing apparatus of the present invention, the information reproducing method of the present invention can employ various aspects.

### Embodiment of Computer Program

An embodiment of the computer program of the present invention is a computer program for reproduction control and for controlling a computer provided in the aforementioned information reproducing apparatus of the present invention (including its various aspects), the computer program making the computer function as at least one portion of the first controlling device, the judging device, and the second controlling device.

According to the computer program of the present invention, the aforementioned information reproducing apparatus of the present invention (including its various aspects) can be relatively easily realized as a computer reads and executes the computer program from a program storage device, such as a ROM, a CD-ROM, a DVD-ROM, and a hard disk, or as it executes the computer program after downloading the program through a communication device.

Incidentally, in response to the various aspects of the aforementioned information reproducing apparatus of the present invention, the computer program of the present invention can also employ various aspects.

The above object of the present invention can be also achieved by a computer program product in a computer-readable medium for tangibly embodying a program of instructions executable by a computer provided in the aforementioned information reproducing apparatus of the present invention (including its various aspects), the computer program product making the computer function as at least one portion of the first controlling device, the judging device, and the second controlling device.

According to the computer program product of the present invention, the aforementioned information reproducing apparatus of the present invention can be embodied relatively readily, by loading the computer program product from a recording medium for storing the computer program product, such as a ROM (Read Only Memory), a CD-ROM (Compact Disc-Read Only Memory), a DVD-ROM (DVD Read Only Memory), a hard disk or the like, into the computer, or by downloading the computer program product, which may be a carrier wave, into the computer via a communication device. More specifically, the computer program product may include computer readable codes to cause the computer (or may comprise computer readable instructions for causing the computer) to function as the aforementioned information reproducing apparatus of the present invention.

Incidentally, in response to the various aspects of the aforementioned information reproducing apparatus of the present invention, the computer program product of the present invention can also employ various aspects.

These effects and other advantages of the present invention will become more apparent from the example explained below.

As explained above, according to the embodiment of the information reproducing apparatus of the present invention, it is provided with the reproducing device, the first controlling device, the judging device, and the second controlling device.

According to the embodiment of the information reproducing method of the present invention, it is provided with the first controlling process, the judging process, and the second controlling process.

According to the embodiment of the computer program of the present invention, it makes a computer function as one portion of the embodiment of the information reproducing apparatus of the present invention.

Therefore, it is possible to reproduce the AV content or the like while appropriately reflecting the user's instruction.

### EXAMPLE

Hereinafter, the preferred example of the present invention will be explained with reference to the drawings.

### (1) Basic Structure of Information Recording/Reproducing Apparatus

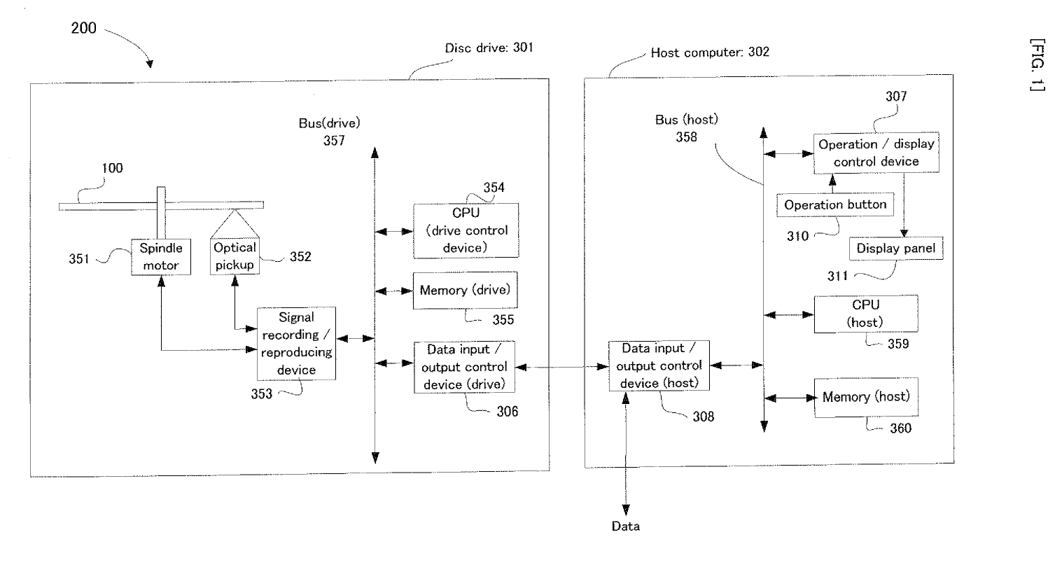

Firstly, with reference to FIG. 1, a description will be given on the basic structure of an information recording/reproducing apparatus, as an example of the information reproducing apparatus of the present invention. FIG. 1 is a block diagram conceptually showing the basic structure of an information recording/reproducing apparatus 200 in the example. Incidentally, the information recording/reproducing apparatus 200 has a function of recording data onto an optical disc 100 and a function of reproducing the data recorded on the optical disc 100.

As shown in FIG. 1, the information recording/reproducing apparatus 200 is provided with: a disc drive 301 on which the optical disc 100 is actually loaded and on which data recording and data reproduction are performed; and a host computer 302, such as a personal computer, for controlling the data recording and reproduction with respect to the disc drive 301.

The disc drive 301 is provided with: the optical disc 100; a spindle motor 351; an optical pickup 352; a signal recording/reproducing device 353; a CPU (drive control device) 354; a memory 355; a data input/output control device 306; and a bus 357. Moreover, the host computer 302 is provided with: a CPU 359; a memory 360; an operation/display control device 307; an operation button 310; a display panel 311; and a data input/output control device 308.

The spindle motor 351 is intended to rotate and stop the optical disc 100, and operates upon accessing the holographic recording medium 1. More specifically, the spindle motor 351 is adapted to rotate the optical disc 100 at a predetermined speed and stop it, under spindle servo from a not-illustrated servo unit or the like.

The optical pickup 352 is provided with e.g. a semiconductor laser diode, a collimator lens, an objective lens, and the like, in order to perform the recording and the reproduction on the optical disc 100. More specifically, the optical pickup 352 irradiates the optical disc 100 with a laser beam LB with a first power as reading light in the reproduction, and with a second power and with it modulated as writing light in the recording.

The signal recording/reproducing device 353 constitutes one specific example of the “reproducing device” of the present invention, and controls the spindle motor 351 and the optical pickup 352, to thereby perform the recording and the reproduction on the optical disc 100. More specifically, the signal recording/reproducing device 353 is provided with e.g. a laser diode driver (LD driver), a head amplifier, and the like. The laser diode driver generates e.g. a driving pulse and drives the semiconductor laser element disposed in the optical pickup 352. The head amplifier amplifies an output signal of the optical pickup 352, i.e. reflected light of the laser beam LB, and outputs the amplified signal.

The memory 355 is used in the general data processing and an OPC process on the disc drive 301, including a buffer area for the record/reproduction data, an area used as an intermediate buffer when data is converted into the data that can be used on the signal recording/reproducing device 353, and the like. Moreover, the memory 355 is provided with: a ROM area into which a program for performing an operation as the recorder equipment, i.e. firmware, is stored; a buffer for temporary storage of the record/reproduction data; a RAM area into which a parameter required for the operation of a firmware program or the like is stored; and the like.

The CPU (drive control device) 354 is connected to the signal recording/reproducing device 353 and the memory 355 through the bus 357, and controls the entire disc drive 301 by giving an instruction to various controlling devices. Typically, software or firmware for operating the CPU 354 is stored in the memory 355.

The data input/output control device 306 controls the input/output of the data from the exterior with respect to the disc drive 301, to thereby perform storage to and export from the data buffer on the memory 355. A drive control command issued from the external host computer 302 connected to the disc drive 301 through an interface, such as a SCSI and an ATAPI, is transmitted to the CPU 354 through the data input/output control device 306. Moreover, the data is also exchanged with the host computer 302 through the data input/output control device 306, in the same manner.

The operation/display control device 307 constitutes one specific example of the “inputting device” of the present invention. The operation/display control device 307 receives an operation instruction and performs display with respect to the host computer 302, and transmits an instruction by the operation button 310, such as an instruction to record, to the CPU 359. The CPU 359 may transmit a control command to the information recording/reproducing apparatus 200, through the data input/output control device 308, on the basis of instruction information from the operation/display control device 307, to thereby control the entire disc drive 301. In the same manner, the CPU 359 can transmit a command for requesting the disc drive 301 to transmit an operational state to the host, with respect to the disc drive 301. By this, the operational state of the disc drive 301, such as during recording, can be recognized, so that the CPU 359 can output the operational state of the disc drive 301 to the display panel 311, such as a fluorescent tube and an LCD, through the operation/display control device 307.

The memory 360 is an internal memory apparatus used by the host computer 302, and it is provided with: a ROM area in which a firmware program, such as BIOS (Basic Input/Output System), is stored; a RAM area in which variables necessary for the operation of an operating system and an application program or the like are stored; and the like. Moreover, the memory 360 may be connected to an external memory apparatus, such as a not-illustrated hard disk, through the data input/output control device 308.

One specific example used by combining the disc drive 301 and the host computer 302, as explained above, is household equipment, such as recorder equipment for recording and reproducing pictures. The recorder equipment records a video signal from a broadcast reception tuner and an external connection terminal, onto a disc. The operation as the recorder equipment is performed by executing a program stored in the memory 360, on the CPU 359. Moreover, in another specific example, the disc drive 301 is a disc drive (hereinafter referred to as a “drive”, as occasion demands), and the host computer 302 is a personal computer and a work station. The host computer, such as the personal computer, and the drive are connected through the data input/output control devices 306 and 308, such as the SCSI and the ATAPI, and application, such as writing software, installed in the host computer 302 controls the disc drive 301.

### (2) Logical Structure of Data Recorded on Optical Disc

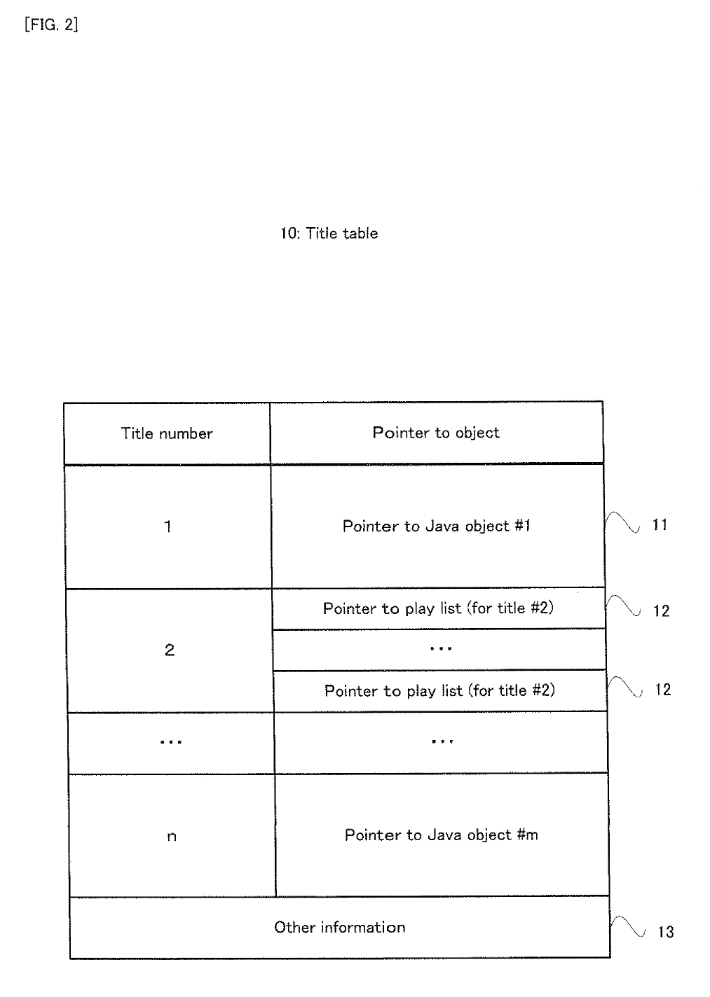

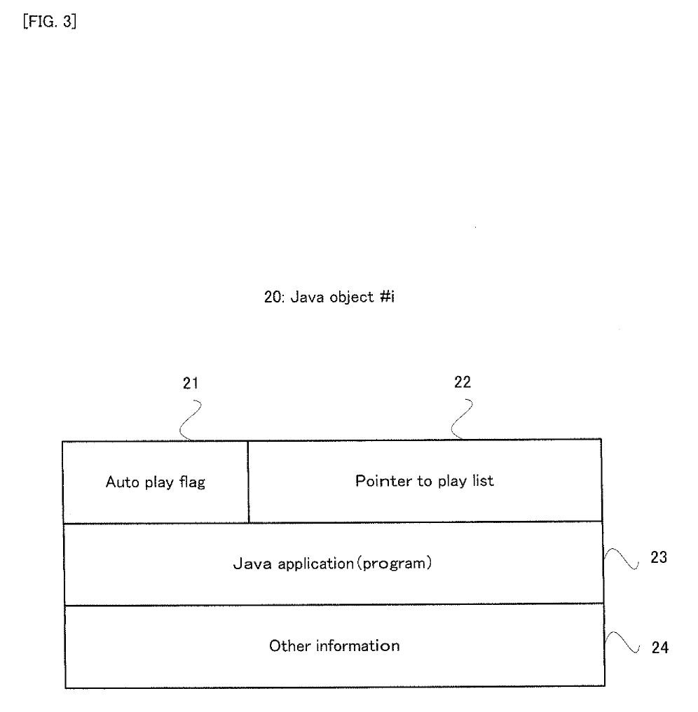

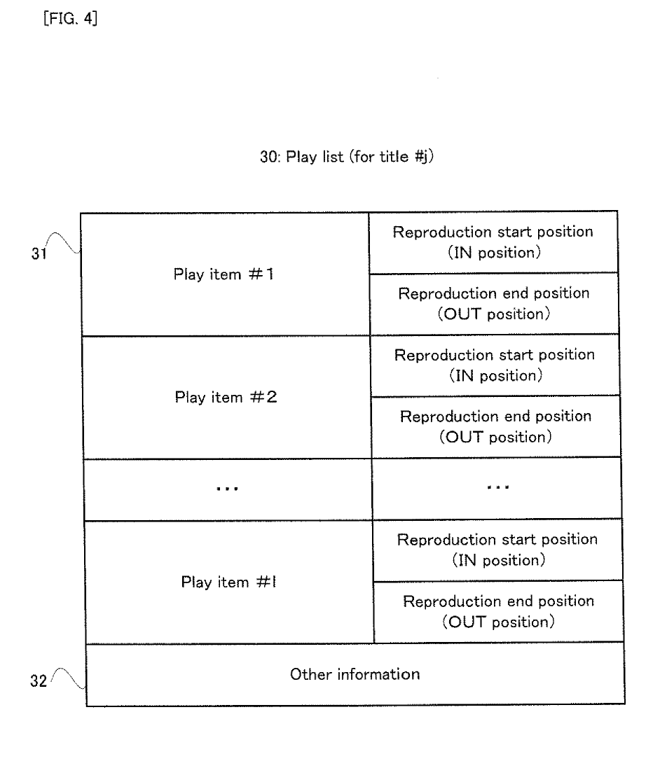

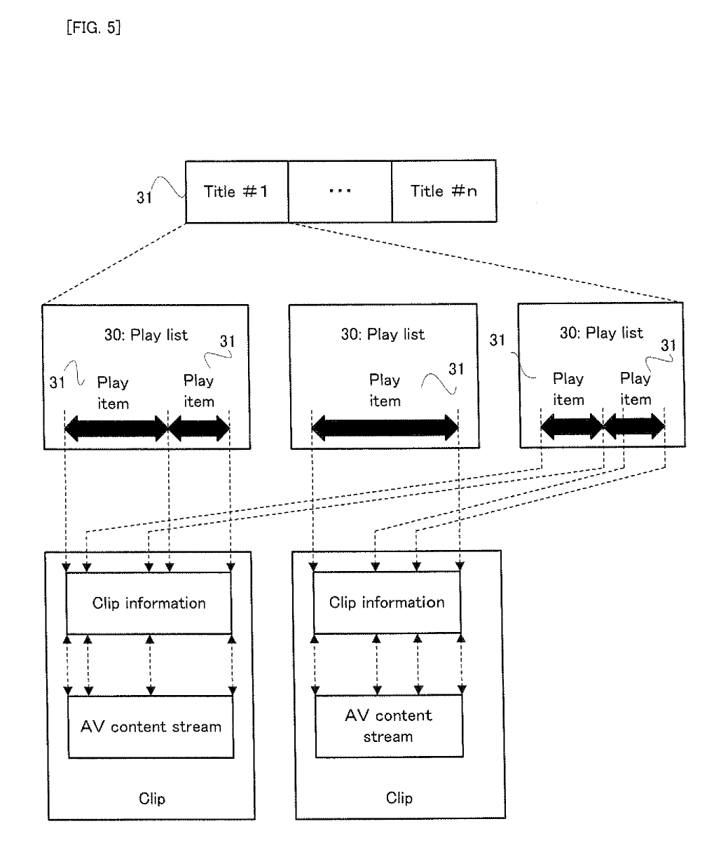

Next, with reference to FIG. 2 to FIG. 5, a description will be given on the logical structure of the data on the optical disc 100. FIG. 2 is a data structure diagram conceptually showing the logical structure of a title table. FIG. 3 is a data structure diagram conceptually showing the logical structure of a Java object. FIG. 4 is a data structure diagram conceptually showing the logical structure of a play list. FIG. 5 is a data structure conceptually showing a hierarchical relationship of the logical structure of the data.

As shown in FIG. 2, a title table 10 is recorded on the optical disc 100, wherein the title table 10 indicates objects that constitute a plurality of titles. Here, the title is AV content unit which has a logically large group, such as one movie and one TV program. As described later the title is an AV content reproduction unit in which at least one “play list” is reproduced.

On the title table 10, there are recorded pointers 11 which indicate the storage positions of Java objects #1 to #m (wherein m is an integer or 1 or more), which constitute each title, and pointers 12 which indicate the storage positions of the play lists (for titles #1 to #n) which constitute each title (in other words, pointers that indicate the storage positions of movie objects, which have commands such as play lists, and in which the play lists are reproduced by the commands), in each of the title numbers #1 to #n (wherein n is an integer or 1 or more) for identifying the title. Here, the “play list” is a file in which information necessary for the reproduction of the AV content is stored. As described later, the play list is provided with a plurality of “play items” in each of which information about the reproduction range of the AV content is stored to access the AV content.

Moreover, on the title table 10, there is recorded other information 13 except the aforementioned pointers 11 and pointers 12.

Incidentally, FIG. 2 exemplifies the title table 10 in the case where the plurality of titles are recorded on the optical disc 100. If one title is recorded on the optical disc 100, the present invention employs such construction that the pointers 11 to the Java objects which constitute the one title and the pointers 12 to the playlists which constitute the one title are recorded.

Moreover, FIG. 2 exemplifies the title table 10 in which the reproduction unit which is obtained by continuously executing the plurality of play lists, is set as one title; however, it is obvious that a reproduction unit which is obtained by executing a single play list may be set as one title.

Moreover, FIG. 2 exemplifies the title table 10 in which each title has the Java objects; however, it may includes a title that does not have the Java objects. In this case, the title that has the Java objects is reproduced by the operation of a Java application 23 described later after the Java application 23 is executed. The title that does not have the Java objects is reproduced in accordance with e.g. a sequence indicated by the play lists, without the Java application 23 described later being executed.

As shown in FIG. 3, the Java object #i (wherein 1≦i≦m) 20 whose position is indicated by the pointer 11 recorded in the title table 10, includes: an auto play flag 21; a pointer 22 which indicates a storage position of the play list; a Java application 23 executed to control the reproduction of the AV content which constitutes the title; and other information 24.

The auto play flag 21 indicates whether or not the pointer 22 included in the Java object #i is the pointer to the play list which starts to be reproduced before the reading and launch of the Java application 23 are completed. For example, if the auto play flag 21 indicates “1”, the play list starts to be reproduced before the reading and launch of the Java application 23 are completed (hereinafter referred to as an “advance AV content”, as occasion demands). On the other hand, if there is no AV content that is reproduced in advance, the auto play flag 21 indicates “0”, and the play list is not reproduced before the reading and launch of the Java application 23 are completed.

As shown in FIG. 4, the play list 30 includes a plurality of play items 31 and other information 32.

Each of the plurality of play items 31 includes a reproduction start position (in other words, an IN position) of the AV content and a reproduction end position (in other words, an OUT position) of the AV content. Incidentally, the reproduction start position and the reproduction end position are preferably indicated by a time stamp (i.e. a reproduction time length or a reproduction time point) on a reproduction time axis of the AV content.

Moreover, the play list 30 preferably includes the position(s) of one or a plurality of chapters included in the AV content.

As shown in FIG. 5, the data structure explained in FIG. 2 to FIG. 4 has a hierarchical relationship. That is, one title is provided with one or a plurality of play lists 30, and one play list 30 is provided with one or a plurality of play items 31.

Then, the play item 31 indicates an access point in a clip by the reproduction start position and the reproduction end position described above. Incidentally, the “clip” in the example indicates a pair of one AV content stream file (i.e. an actual data file of the AV content, for example, a MPEG 2 transport stream) and clip information, which is information corresponding thereto. Moreover, the data file of the clip information is referred to as a clip information file.

The reproduction start position and the reproduction end position shown as the time stamp by the play item 31 are converted to address information at which decoding is to be started in the AV content stream file by using the clip information file. Thus, the clip information preferably includes a table or the like which indicates a correspondence relationship between the time stamp and the address information.

For example, in FIG. 5, the title #1 shown at the first from the left is provided with three play lists 30. The first play list 30, shown on the left side in FIG. 5 of the three play lists, is provided with two play items 31. The two play items 31 refer to a former half portion and a latter half portion of an AV content stream included in the first clip shown on the left side in FIG. 5. Thus, if the first play list 30 is selected, the former half portion and the latter half portion of the AV content stream included in the first clip are reproduced.

Moreover, the second play list 30 shown on the middle side in FIG. 5 of the three play lists 30 is provided with one play item. The one play item 31 refers to an entire AV content stream included in the second clip shown on the right side in FIG. 5. Thus, if the second play list 30 is selected, the entire AV content stream included in the second clip is reproduced.

Moreover, the third play list 30 shown on the right side in FIG. 5 of the three play lists is provided with two play items 31. The two play items 31 refer to one portion of the AV content stream included in the first clip and one portion of the AV content stream included in the second clip. Thus, if the third play list 30 is selected, one portion of the AV content stream included in the first clip and one portion of the AV content stream included in the second clip are reproduced.

As described above, from the viewpoint of the logical structure of the data recorded on the optical disc 100, the information recording/reproducing apparatus 200 in the example reproduces the AV content recorded on the topical disc 100 by following the hierarchical data structure shown in FIG. 5 as needed.

### (3) Operation Principle of Information Recording/Reproducing Apparatus

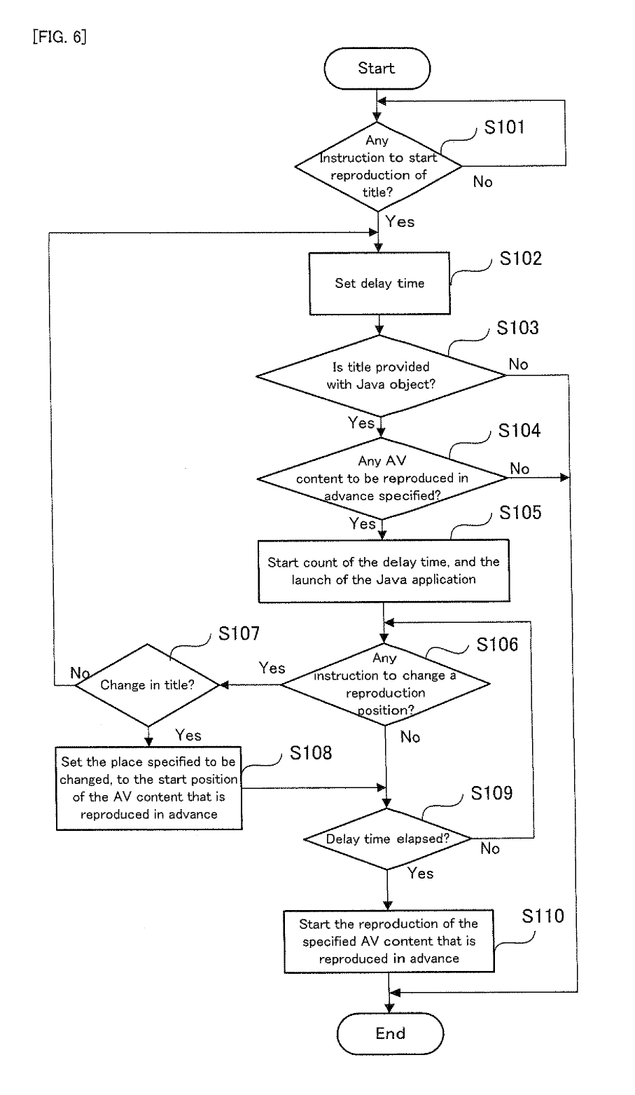

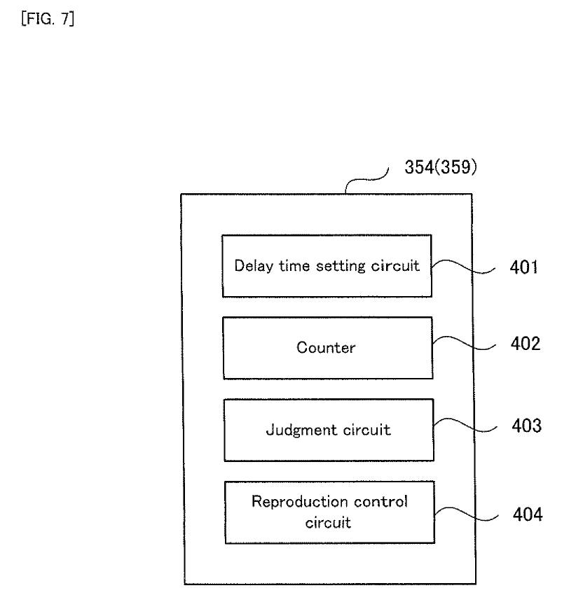

Next, with reference to FIG. 6 and FIG. 7, a description will be given on the more detailed aspect of the reproduction operation (specifically, the aspect of the operation when the Java application 23 is read) of the information recording/reproducing apparatus 200 in the example. FIG. 6 is a flowchart conceptually showing a flow of the operation of the information recording/reproducing apparatus in the example. FIG. 7 is a block diagram conceptually showing a logical circuit structure inside the CPU 354 or 359, provided for the information recording/reproducing apparatus 200, to realize the operation shown in FIG. 6.

Incidentally, the flowchart shown in FIG. 6 indicates the operation after the title (in other words, the AV content) to be reproduced has been already selected by the user.

As shown in FIG. 6, it is judged whether or not an instruction to start the reproduction of the title (AV content) is given by the user (step S101).

As a result of the judgment in the step S101, if it is judged that the instruction to start the reproduction of the title is not given by the user (the step S101: No), it stands by until the instruction to start the reproduction of the title is given.

On the other hand, as a result of the judgment in the step S101, if it is judged that the instruction to start the reproduction of the title is given by the user (the stop S101: Yes), then, a delay time is set which indicates a time to delay the start of the reproduction of the advance AV content which is reproduced during the reading and the launch of the Java application 23 (step S102). The setting of the delay time is performed by a setting circuit 401 in FIG. 7, which indicates one specific example of the “setting device” of the present invention.

The delay time may be set in accordance with the data size of the Java application 23 launched. For example, if the data size of the Java application 23 launched is relatively large, a relatively long delay time may be set. Alternatively, if the data size of the Java application 23 launched is relatively small, a relatively short delay time may be set.

Alternatively, the delay time may be set in accordance with a time required from the start of the launch of the Java application 23 to the completion thereof. For example, if a relatively long time is required from the start of the launch of the Java application 23 to the completion thereof, the relatively long delay time may be set. Alternatively, if a relatively short time is required from the start of the launch of the Java application 23 to the completion thereof the relatively short delay time may be set. More specifically, if for example, 10 seconds is required from the start of the launch of the Java application 23 to the completion thereof, “5 seconds” may be set as the delay time.

Incidentally, the time required from the start of the launch of the Java application 23 to the completion thereof depends on the data size of the Java application 23 launched. Thus, the aforementioned two aspects of setting the delay time are substantially the same.

Incidentally, even if the setting by the setting circuit 401 is not performed every time the title is selected, for example, the delay time of default may be set in advance. In this case, the delay time of default is preferably set in accordance with the data size of the Java application 23 launched (or the time required from the start of the launch of the Java application 23 to the completion thereof.

Then, it is judged whether or not the title selected by the user includes the Java object 20 (step S103).

Here, for example, the judgment may be performed on the basis of whether or not the pointer 11 to the Java object 20, which corresponds to the title selected by the user, is recorded in the title table 10. If the pointer 11 to the Java object 20, which corresponds to the title selected by the user, is recorded in the title table 10, it is judged that the title selected by the user includes the Java object 20. On the other hand, if the pointer 11 to the Java object 20, which corresponds to the title selected by the user, is not recorded, it is judged that the title selected by the user does not include the Java object 20.

As a result of the judgment in the step S103, if it is judged that the title selected by the user does not include the Java object 20 (the step S103: No), the following process is not performed, and the title is reproduced in accordance with the play lists 30.

On the other hand, as a result of the judgment in the step S103, if it is judged that the title selected by the user includes the Java object 20 (the step S103: Yes), then it is judged whether or not the advance AV content is specified (step S104).

Here, the judgment of whether or not the advance AV content is specified may be performed on the basis of the auto play flag 21 included in the Java object 20.

As a result of the judgment in the step S104, if it is judged that the advance AV content is not specified (the step S104: No), the launch of the Java application 23 is started without reproducing the advance AV content, and after the launch is completed, the title is reproduced, for example, in an interactive aspect according to the operation of the Java application 23. In this case, a blue back screen or the like may be displayed on a display by the operation of a reproduction control circuit 404 in FIG. 7 from the start of the launch of the Java application 23 to the completion thereof.

On the other hand, as a result of the judgment in the step S104, if it is judged that the advance AV content is specified (the step S104: Yes), countdown is started, with the delay time set in the step S102 as an initial value, by the operation of a counter 402 in FIG. 7, and the launch of the Java application 23 is started (step S105).

At this time, the advance AV content is not reproduced by the operation of the reproduction control circuit 404 in FIG. 7, which constitutes one specific example of the “first controlling device” of the present invention.

Incidentally, the launch of the Java application 23 is performed in order to virtually mount a computer having an architecture which is referred to as a Java virtual machine on the CPU 354 or 359 and to operate the Java application 23 on the Java virtual machine. That is, it can be said that the launch of the Java application 23 is completed at the time point that the mount of the Java virtual machine is completed and that it is ready to operate the Java application 23 on the Java virtual machine.

Then, by the operation of a judgment circuit 403 in FIG. 7, which constitutes one specific example of the “judging device” of the present invention, it is judged whether or not the user has given an instruction to change a reproduction position (e.g. an instruction to reproduce another title, a fast-forward instruction, a rewind instruction, a chapter change instruction, and the like) (step S106).

As a result of the judgment in the step S106, if it is judged that the user has not given the instruction to change the reproduction position (the step S106: No), then it is judged whether or not the delay time has elapsed after the launch of the Java application 23 is started (step S109). In other words, it is judged whether or not a count value on the counter 402 is “0”. If the counter value on the counter 402 is “0”, it is judged that the delay time has already elapsed after the launch of the Java application 23 is started. On the other hand, if the counter value on the counter 402 is not“0”, it is judged that the delay time has not elapsed yet after the launch of the Java application 23 is started.

As a result of the judgment in the step S109, if it is judged that the delay time has not elapsed after the launch of the Java application 23 is started (the step S109: No), the operational flow returns to the step S106 again to continue the process after the step S106.

On the other hand, as a result of the judgment in the step S109, if it is judged that the delay time has elapsed after the launch of the Java application 23 is started (the step S109: Yes), the reproduction of the specified advance AV content is started by the operation of the reproduction control circuit 404, which constitutes one specific example of the “second controlling device” of the present invention (step S110). After that, if the launch of the Java application is completed, the title is reproduced, for example, in an interactive aspect according to the operation of the Java application 23.

Incidentally, the advance AV content continues to be reproduced even after the launch of the Java application 23 is completed. And the reproduction is stopped, for example, after an instruction to stop the reproduction is given by the user.

On the other hand, as a result of the judgment in the step S106, if it is judged that the user has given the instruction to change the reproduction position (the step S106: Yes), it is judged whether or not the user's instruction is an instruction to change a reproduction position in the same title (e.g. a fast-forward instruction, a rewind instruction, a chapter change instruction, and the like) (step S107).

As a result of the judgment in the step S107, if it is judged that the user's instruction is not the instruction to change a reproduction position in the same title (e.g. that the user's instruction is an instruction to reproduce another title) (the step S107: No), the operational flow returns to the step S102, and the processes after the step S102 are performed on the title changed by the instruction.

On the other hand, as a result of the judgment in the step S107, if it is judged that the user's instruction is the instruction to change a reproduction position in the same title (e.g. that the user's instruction is an instruction to reproduce another title) (the step S107: Yes), the changed reproduction position is set to the reproduction start position (in other words, reproduction start time point) of the advance AV content (step S108). Then, if the delay time has passed since the launch of the Java application 23, the reproduction of the specified advance AV content is started from the reproduction start position set in the step S108 by the operation of the reproduction control circuit 404. p As explained above, according to the information recording/reproducing apparatus 200 in the example, the reproduction of the advance AV content is not started in the predetermined period after the reading and launch of the Java application 23 are started (specifically, until the delay time set in the step S102 in FIG. 6 has elapsed), and the instruction from the user can be inputted. Therefore, the reproduction of the title based on the user's instruction can be performed in the predetermined period. In other words, even after the launch of the Java application 23 is started, it is possible to reproduce the title while reflecting the user's instruction. Specifically, for example, in the case that the user gives an instruction to start the reproduction of a second title whose reproduction is not controlled by the Java application 23 after the user gives an instruction to start the reproduction of a first title whose reproduction is controlled by the Java application 23, the reproduction of the second title can be started as long as the instruction to start the reproduction of the second title is given in the predetermined period after the launch of the application that controls the reproduction of the first title.

As described above, according to the information recording/reproducing apparatus 200 in the example, it is possible to preferably reproduce the title or the like while appropriately reflecting the user's instruction.

Incidentally, in the aforementioned example, the Java application 23 is explained as the application that controls the reproduction aspect of the title; however, obviously the aforementioned various benefits can be received by performing the aforementioned operation with an application other than the Java application 23. For example, in addition to or instead of the Java application 23, an application that operates on the virtual machine, which is mounted on the CPU 354 or 359 provided for the information recording/reproducing apparatus 200, as in the Java application 23, may be used.

Incidentally, in the aforementioned example, an explanation is given on the optical disc 100 as one example of the information recording medium and the player related to the optical disc 100 as one example of the information reproducing apparatus; however, the present invention is not limited to the optical disc and the player for the optical disc, and it can be also applied to other various information recording media which support high-density recording or high transmission rate, and players for the various information recording media.

Moreover, obviously, not only the information recording/reproducing apparatus for reproducing the AV content(s) recorded on the topical disc 100 but also an information recording/reproducing apparatus for reproducing the AV content(s) received through a wired line or wireless line, such as TV broadcasting and the Internet, can receive the aforementioned various benefits by performing the aforementioned operations.

The present invention is not limited to the aforementioned embodiment, but various changes may be made, if desired, without departing from the essence or spirit of the invention which can be read from the claims and the entire specification. An information reproducing apparatus and method, and a computer program, all of which involve such changes, are also intended to be within the technical scope of the present invention.

### INDUSTRIAL APPLICABILITY

The information reproducing apparatus and method, and the computer program according to the present invention can be applied to an information reproducing apparatus, such as a DVD player. Moreover, they can be applied to an information reproducing apparatus or the like which is mounted on various computer equipment for consumer use or for commercial use, or which can be connected to various computer equipment.

1-12. (canceled)

13. An information reproducing apparatus comprising:
a reproducing device for reproducing at least one of normal content data and advance content data whose reproduction is started before launch of an application for controlling reproduction of the normal content data is completed;
a first controlling device for controlling said reproducing device to delay the start of the reproduction of the advance content data, for a predetermined period from the start of the launch of the application;
a judging device for judging whether or not an instruction related to the reproduction is given in the predetermined period; and
a second controlling device for controlling said reproducing device to start the reproduction of the advance content data before the launch of the application is completed and after the predetermined period has elapsed if it is judged that the instruction is not given, and for controlling said reproducing device to perform the reproduction based on the instruction, instead of starting the reproduction of the advance content data, if it is judged that the instruction is given.

14. The information reproducing apparatus according to claim 13, wherein the application includes a Java application.

15. The information reproducing apparatus according to claim 13, wherein the application includes a HTML application.

16. The information reproducing apparatus according to claim 13, wherein the application includes an application that operates on a virtual machine which is mounted on the information reproducing apparatus.

17. The information reproducing apparatus according to claim 13, wherein the predetermined period is less than or equal to a time required from the start of the launch of the application to the completion thereof.

18. The information reproducing apparatus according to claim 13, wherein the predetermined period is set on the basis of a time required from the start of the launch of the application to the completion thereof.

19. The information reproducing apparatus according to claim 13, further comprising a setting device for setting the predetermined period on the basis of a time required from the start of the launch of the application to the completion thereof.

20. The information reproducing apparatus according to claim 13, further comprising an inputting device for a user of the information reproducing device to input the instruction to the information reproducing apparatus.

21. An information reproducing method in an information reproducing apparatus comprising: a reproducing device for reproducing at least one of normal content data and advance content data whose reproduction is started before launch of an application for controlling reproduction of the normal content data is completed,
said information reproducing method comprising:
a first controlling process of controlling said reproducing device to delay the start of the reproduction of the advance content data, for a predetermined period from the start of the launch of the application;
a judging process of judging whether or not an instruction related to the reproduction is given in the predetermined period; and
a second controlling process of controlling said reproducing device to start the reproduction of the advance content data before the launch of the application is completed and after the predetermined period has elapsed if it is judged that the instruction is not given, and for controlling said reproducing device to perform the reproduction based on the instruction, instead of starting the reproduction of the advance content data, if it is judged that the instruction is given.

22. A computer program product in a computer-readable medium for tangibly embodying a program of instructions executable by a computer provided in the information reproducing apparatus according to claim 13, said computer program making the computer function as at least one portion of said first controlling device, said Judging device, and said second controlling device.
